(19) United States
(12) Patent Application Publication
(10) Pub. No.: US 2019/0138963 A1
(43) Pub. Date: May 9, 2019

(54) METHOD AND SYSTEM FOR SELF LEARNING LOCATION SELECTION AND TIMING PREDICTION

(71) Applicant: Raisa II Holdings, LLC, Denver, CO (US)

(72) Inventors: Motaz El Saban, New Cairo (EG); Paul Schietinger, Broomfield, CO (US); Ayman Kaheel, Denver, CO (US); Curtis Caile, Castle Rock, CO (US); Sophia Berglund, Boulder, CO (US); Luis Rodriguez, Austin, TX (US)

(21) Appl. No.: 15/804,044

(22) Filed: Nov. 6, 2017

(51) Int. Cl. G06Q 10/06; G06Q 10/04; G06F 15/18; E21B 47/00

(52) U.S. Cl. CPC G06Q 10/06314; G06Q 10/04; G06Q 10/06316; E21B 2041/0028; G06F 15/18; E21B 47/00; G06Q 10/06313

(57) ABSTRACT

A self-learning system, a method, and a non-transitory computer readable medium having computer executable instructions stored thereon, where each assist in determining a total time prediction for a potential project involving heavy equipment and heavy equipment information. Each may include calculating a prediction for a heavy equipment number, a well density number, how long a heavy equipment will take to move from well to well, a well quantity, and how long a total project will take given a specific area of land and the geological properties thereof. The self-learning system, method, and non-transitory computer readable medium involve a recursion step, wherein the calculation of a prediction is updated when new information is attained.

### BACKGROUND

Data is often collected on heavy equipment such as construction equipment or drilling rigs, for instance, those involved in oil and gas exploration and production. Such data may include surface-based measurements about the equipment for any given day or taken at any time interval, such as rig location (e.g., Global Position Satellite (GPS), TRS (township, range, and section information), latitude, and longitude), well American Petroleum Institute (API) number, well surface location, a commodity basin location, well lateral length, an expected ultimate recovery at the commodity basin location, geography at the project location, basin distance from current rig position, well or target formation, formation depth, and commodity type (oil or gas). Additional data about the drilling site or process may be measured and recorded (commonly known as measurements while drilling (MWD)) and may include daily oil price, production data, permit approval date and expiration, permit depth, rig spud date, rig release date, permit location, and state regulations affecting the distance between wells or drilling spacing units (DSU). Recorded data may further include information about the equipment itself, such as operator name and information, rig name or rig identification (ID), rig capabilities such as drill horse power, maximum movement speed, and other rig capabilities.

Users of heavy equipment and the companies interested in their operation typically use human intelligence to analyze a terrain or a given portion of land to determine how long it will take to drill a preset amount of wells in a predetermined size of the land. However, due to limitations in using such techniques, the results have been disappointing and require a lengthy amount of time to obtain. Such results include the timeline of how long it will take to complete a task, e.g., drill a preset amount of wells for a predetermined size of terrain, and require human subjective intervention.

### SUMMARY

The following presents a simplified summary of the disclosure in order to provide a basic understanding of some aspects of the disclosure.

The systems and methods disclosed herein may, among other things, allow for the determination of: a number of rigs used in a potential project for a third party operator, number of wells dug in a potential project, well density for a third party operator, and rig movement for a particular operator, time of movement, and/or time to complete a task, all determined by a self-learning manner, to predict the total time to complete a potential project, e.g., drill a preset amount of wells in a defined area of terrain or move to a specific location or area to drill a well.

In embodiments, the method described herein is a predictive method based on previous human decisions that were made at the beginning and during a previous project involving heavy equipment (e.g., drilling wells). The method is faster, more efficient, more flexible, and improves computer technology due to the contribution of the self-learning aspect of the disclosure. To be able to accurately predict the total time for a project, the systems and methods discussed below calculate for a potential project: a rig count, well density, quantity of wells, rig movement, time to complete drilling of all wells, and time of rig movement. The method presents a prediction potentially without foreknowledge of the number of heavy equipment items, or rig movement that will be used and without knowledge of how many wells will be ultimately dug. The method uses historical data to create a model that is regularly updated as additional data is gathered.

More specifically, in an embodiment, a self-learning method to assist in determining a total time to complete a potential project involves a plurality of historical heavy equipment information. The method is implemented on one or more computing systems, which includes a set of rules for: (1) receiving a request for an estimated total time to complete a potential project from a user; (2) accessing a first portion of the historical heavy equipment information for heavy equipment for the operator; (3) calculating how a particular number of rigs (i.e. one) will move in the potential project by the operator based on the first portion of historical heavy equipment information; (4) accessing a second portion of the historical heavy equipment information for the operator; (5) providing an updated rig movement path to be used in the potential project based on the second portion of the historical heavy equipment information; (6) predicting a total estimated time for the potential project utilizing the updated rig movement to be used in the potential project; and (7) sending, in response to the request, the estimated total time to complete the potential project.

In step (1), the potential project includes a quantity of a terrain, or acreage owned by an operator, an operator, and at least one geological property of the terrain. In step (2), the first portion of the historical heavy equipment information includes information concerning how the heavy equipment moved from a first position to a second position by the operator for a first historical project. In step (4), the second portion of the historical heavy equipment information includes information concerning the heavy equipment moved from the second position to a third position in a historical project.

In another embodiment, a self-learning system comprises a processor; an application programing interface that communicates with a heavy equipment database containing a plurality of historical heavy equipment data that is updated at a predetermined time interval; a storage medium for a storing portion of the historical heavy equipment data relating to a specific operator and rig movement; a calculating device for calculating, upon request by a user, a total time to complete a potential project based on the portion of historical heavy equipment information; and an output device for displaying the calculated total time for the potential project. The request by the user comprises information about the potential project including a quantity of a terrain, an operator, and geological property of the terrain. The calculating device updates the calculated total time for the potential project calculation with the data that is updated at the predetermined time interval.

In yet a further embodiment, a non-transitory computer readable medium with computer executable instructions stored thereon, executed by a digital processor to perform a self-learning method, includes instructions for: (1) receiving a request from a user for an estimated total time to complete a potential project, the request including information about the potential project including a quantity of a terrain, an operator, and geological property of the terrain; (2) accessing a first portion of the historical heavy equipment information for heavy equipment for the operator, wherein the first portion of the historical heavy equipment information includes information concerning the movement of the heavy equipment owned by the operator for a first historical project; (3) calculating how a particular number of rigs (i.e. one) will move in the potential project by the operator based on the first portion of historical heavy equipment information; (4) accessing a second portion of the historical heavy equipment information for the operator; (5) providing an updated rig movement path to be used in the potential project based on the second portion of the historical heavy equipment information; (6) predicting a total estimated time for the potential project utilizing the updated rig movement to be used in the potential project; and (7) sending, in response to the request, the estimated total time to complete the potential project.

### BRIEF DESCRIPTION OF THE DRAWINGS

The drawings constitute a part of this specification and may include exemplary embodiments of the present disclosure and illustrate various objects and features thereof.

A further understanding of the disclosure may be recognized by reference to the accompanying drawing in which:

FIG. 1 is an example of an overall self-learning system for determining an estimated total time to complete a well drilling project or the total time to arrive at a specific location, according to one embodiment.

FIG. 2 is a flowchart illustrating one example of a method using a structure to generate a prediction of total time for a given project.

FIG. 3 is a flowchart illustrating one example of a method using a structure for acquisition of heavy equipment historical data.

FIG. 4 is a flowchart illustrating one example of a method using a structure for determining the amount of heavy equipment to be used by an operator on a job site.

FIG. 5 is a flowchart illustrating one example of a method using a structure for determining the well density of a job site and the amount of wells to be dug by the operator.

FIG. 6 is a flowchart illustrating one example of a method using a structure for determining rig movement by the operator.

FIG. 7 is a flowchart illustrating one example of a method using a structure to generate a prediction of total time for a given project.

FIG. 8 illustrates an example simulation of step 604 and step 606 in FIG. 6.

FIG. 9 illustrates another example simulation of step 604 in FIG. 6.

FIG. 10 is a graph showing the accuracy of the method shown in FIG. 6 with respect to several operators.

FIG. 11 is a scatter plot graph of step 710 in the method shown in FIG. 7 with respect to values of true and determined time for rig movement.

FIG. 12 is a histogram showing the distribution of step 710 in the method shown in FIG. 7 with respect to the values of true and determined time for rig movement.

### DETAILED DESCRIPTION

Reference is made in detail to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, and the like.

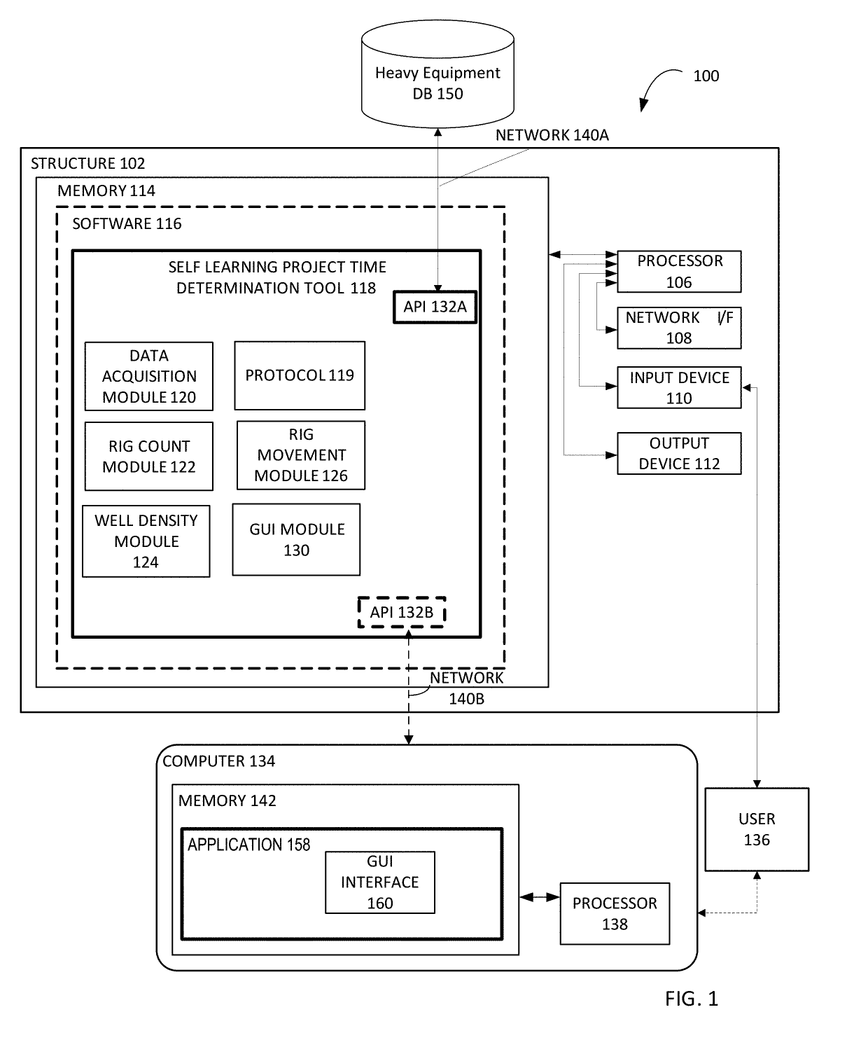

FIG. 1 shows an example self-learning system 100, implemented on a structure 102, that acquires heavy equipment data and estimates rig count, rig movement, well density, and total time for completion of a given project or end location. The structure 102 may be a computing device, such as a desktop computer, a laptop computer, a smart phone, a tablet, a web server or other server, and the like. In embodiments, the structure 102 may be a dedicated computing device adapted to determine rig count, rig movement, well density, and total estimate time to complete a project as with the teachings of the present disclosure.

The structure 102 may include a processor 106, which may be in data communication with a network interface 108, an input device 110, an output device 112, and a memory 114. Processor 106 represents one or more digital processors. Network interface 108 may be implemented as one or both of a wired network interface and a wireless network interface, as is known in the art. The input device 110 may include a keyboard, a mouse, a stylus pen, buttons, knobs, switches, and/or any other device that may allow a user to provide an input to the system 100 via the structure 102. In some embodiments, the input device 110 may comprise a media port (such as a USB port or a SD or microSD port) to allow for media (e.g., a USB drive, a SD or micro SD drive, a laptop memory, a smart phone memory, and the like) to be communicatively coupled to the structure 102. The output device 112 may include one or more visual indicators (e.g., a display, touch screen), audible indicators (e.g., speakers), or any other such output device now known or subsequently developed. In some embodiments, at least a part of the input device 110 and the output device 112 may be combined.

Although shown within the structure 102, memory 114 may be, at least in part, implemented as network storage that is external to the structure 102 and accessed via the network interface 108. The memory 114 may house software 116, which may be stored in a transitory or non-transitory portion of the memory 114. Software 116 includes machine readable instructions that are executed by processor 106 to perform the functionality described herein. In some example embodiments, the processor 106 may be configured through particularly configured hardware, such as an application specific integrated circuit (ASIC), field-programmable gate array (FPGA), and the like, and/or through execution of software (e.g., software 116) to perform functions in accordance with the disclosure herein.

The software 116 may include a self-learning project time determination tool 118, which may be configured to estimate a total time to complete a project including multiple drill sites or it may be used to estimate how long an operator will take to get from a starting location to a secondary location as will be further discussed below. The tool 118 may, in some embodiments, be an application 158, such as a mobile application configured for an Android, Apple, or other device, or as a computer application 158 configured for a mobile computer 134, such as a desktop, laptop, or mobile computer, and the like.

The mobile computer 134 includes a processor 138 in communication with memory 142. In one embodiment, computer 134 is a stationary computer. A user 136 may download the application or program 158 onto computer 134 that enables the computer 134 to communicate with the structure 102 via API 132B. The application 158 is software stored in a non-transitory portion of memory 142, and includes machine readable instructions that are executed by processor 138 to improve functionality of computer 134 and to allow communication with structure 102. As discussed herein, in embodiments, application 158 may provide a graphical user interface 160 that prompts the structure 102 to initiate the total time project determination tool 118. Alternately or additionally, in some embodiments, the tool 118 may be accessible over a network 140B (e.g., over the internet via a password protected or other website, over an intranet, and the like).

The tool 118 may include one or more of a data acquisition module 120, a rig count module 122, a well density module 124, a rig movement module 126, a graphical user interface (GUI) module 130, and API 132A, 132B, each of which are described in more detail herein. A module may be a portion of a computer program and may include instructions for performing a particular function.

The structure 102, via the API 132A, may selectively communicate over a network 140A with a heavy equipment database 150. The heavy equipment database 150 may be a storage medium, such as an optical hard drive, for storing heavy equipment information as data. Historic heavy equipment data may come in the form of records of rig positions (e.g., based on GPS positioning) which may be at discrete time intervals (e.g., daily, hours, by the minute, etc.). Each data point represents a rig position including, for example, degrees of latitude and longitude and may further include a township, range, and section (TRS) description, as well as other relevant information (e.g. heavy equipment type, rig capabilities, etc.). As discussed herein, the tool 118 may be used to import or receive the heavy equipment data and store the data in the memory 114 or database 150.

The structure 102 may be in communication with a solitary computer 134 being used by a user 136 (shown in dashed lines in FIG. 1) or the user may be using the structure input device 110 to interact with the tool 118. Those skilled in the art, however, will appreciate from the disclosure herein that the structure 102 may likewise be configured to communicate with several computers and users that may be unrelated to each other.

In one embodiment, the structure 102 is an online structure 102 which, using protocol 119 and application programming interface (API) 132B, may communicate over a wireless network 140B with the computer 134, such as a desktop computer, mobile computer, a laptop, notebook, tablet, smartphone, et cetera, with which a user 136 interacts. Protocol 119 may be any known internet protocols, such as, IPv6, IPv8, and the like used in the art now or those yet to be known.

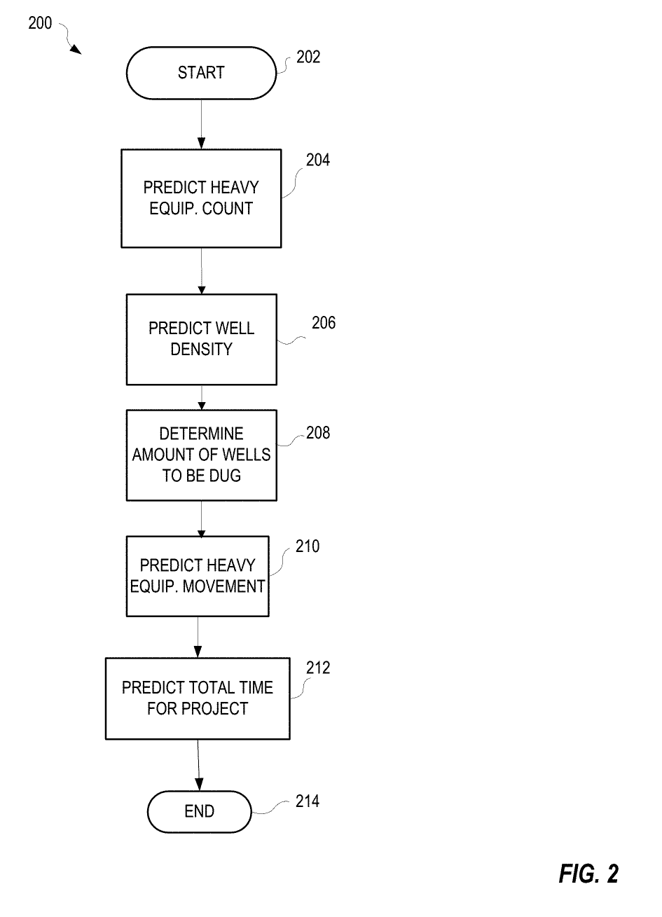

Self-learning methods of estimating a total project time are now described with reference to FIG. 2. FIG. 2 shows an embodiment of the overall method 200. To estimate the time it will take to complete the project, one must have a good prediction of how many rigs an operator will use to complete the project, well-spacing (or well density), and how rigs will move about a particular tract of land to drill the wells. With this information, one can estimate the time it will take to move a “known” amount of rigs about the tract of land and to drill a “known” amount of wells. As will be understood by the description of the method 200 provided below, the estimation of time is accomplished via the total time determination tool 118, which executes a novel set of rules that may be embodied in various sub-methods (e.g., sub-method 300, 400, etc.). Accordingly, the method 200 (and the various sub-methods (e.g., 300, 400, etc.) that make up the method 200) is able to provide a user with a more accurate estimation of time for an operator to complete a project than has previously been known.

To begin, in step 202, the method 200 is initiated by activating the total time determination tool 118 by the user 136 (e.g. through the input device 110). The user 136 may be interacting with a GUI 160 initiated by the GUI module 130, as discussed above. The user 136 may define the potential project including the terrain and geological features and the desired operator to evaluate.

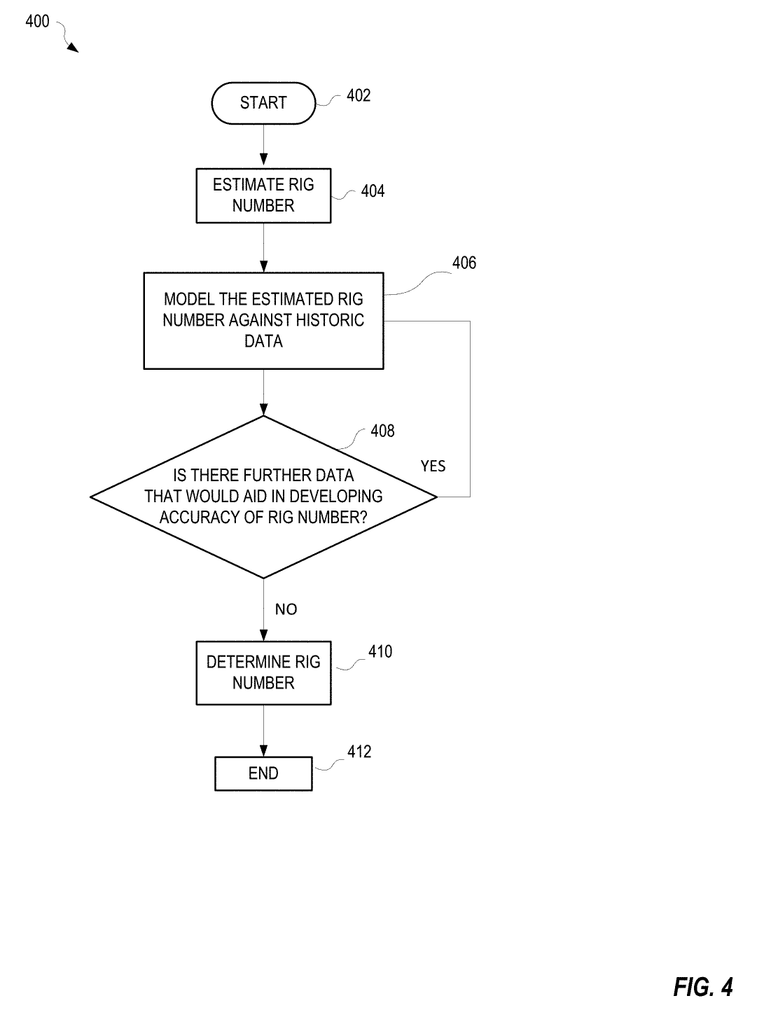

In step 204, an amount of rigs or rig number is predicted or determined. In one embodiment, the prediction may be made by the method 400 as discussed below (FIG. 4). In another embodiment, the number of rigs may be known, for example, if a project has already begun. The data may be stored as historical data and used as described herein.

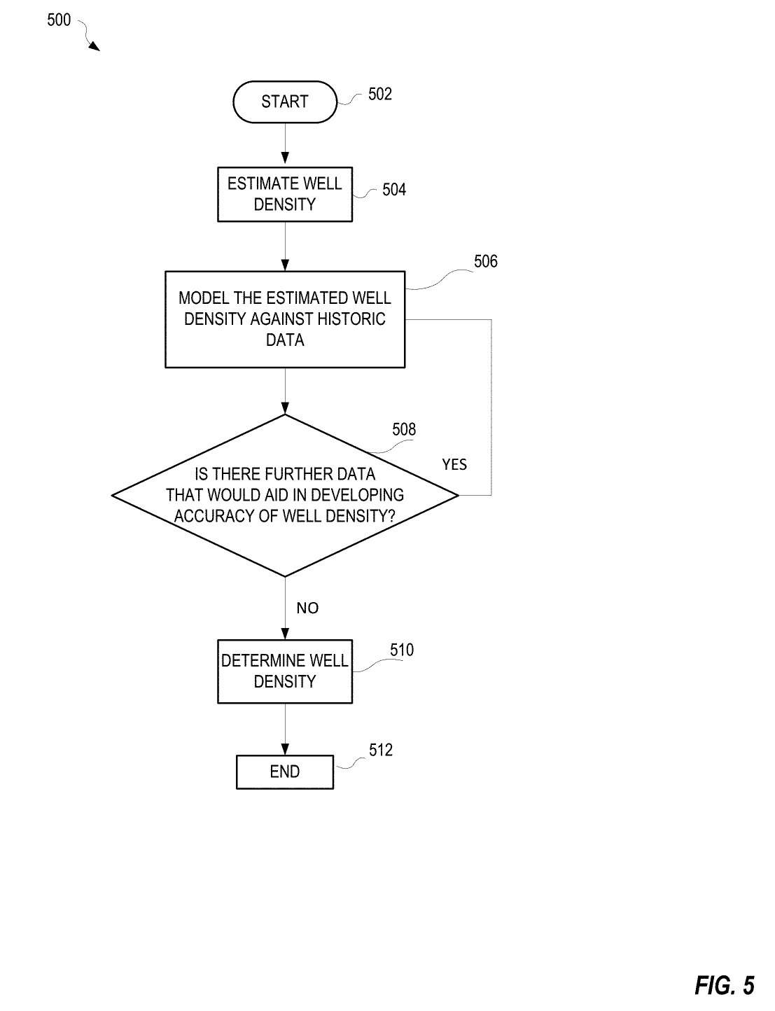

In step 206, well density per drilling spacing unit (DSU) is predicted or determined by method 500 as discussed below (FIG. 5). The method 500 discussed below predicts the well density of a specific location for a potential project for each operator. Variables or factors (e.g. geological properties, estimated ultimate recovery of commodity, and the like) associated with that specific location are factored into the determination of well density, as each relevant factor may have an effect on the operator's ability to complete wells.

In step 208, having estimated the number of rigs at step 204 (e.g., from method 400 in FIG. 4), the well density at step 206 (e.g., from method 500 in FIG. 5), and having a given quantity of land with certain known geological properties, a number of wells to be drilled may then be estimated. The number of wells will determine how many locations a rig (or plurality of rigs) must move to develop the location of land.

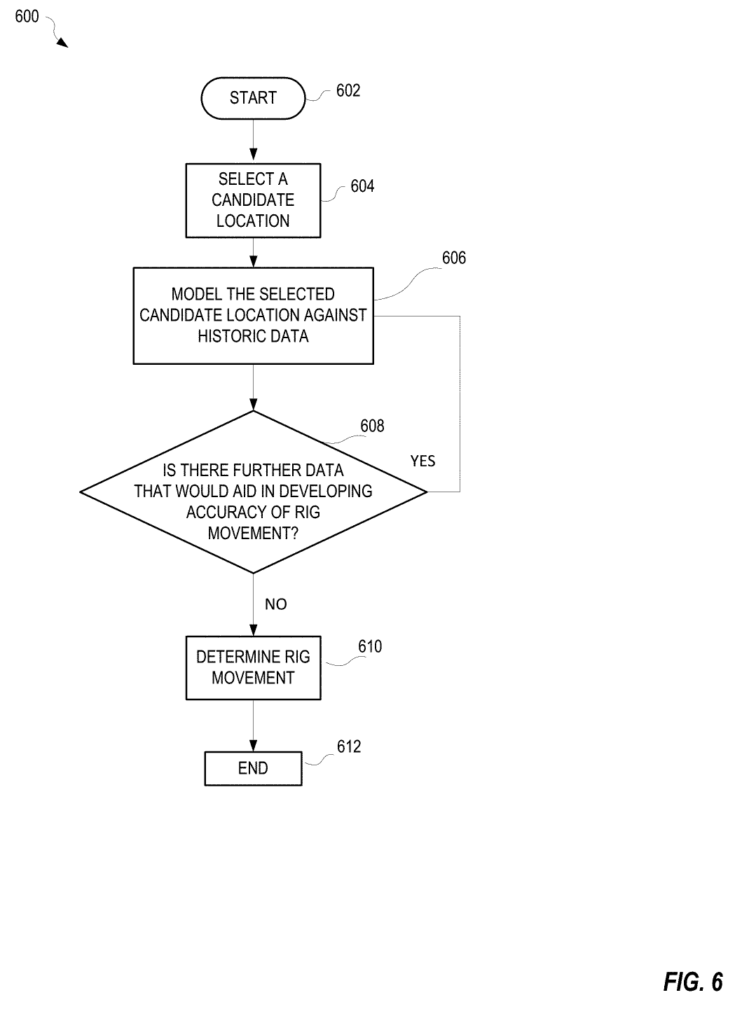

A final determination (or estimation) needed in order to more accurately predict the total time to complete a project is how long it will take the operator to dig the determined amount of wells given the number of rigs being used for the project (or based on the estimated number of rigs). To estimate how long it will take, the method 200 must predict how the heavy equipment will move, as each move affects the overall timing of the project. For example, rigs moving in a straight line (or relatively straight line) may move quicker than rigs that follow a more non-linear path. Accordingly, in step 210, the rig movement is predicted by method 600 as discussed below (FIG. 6).

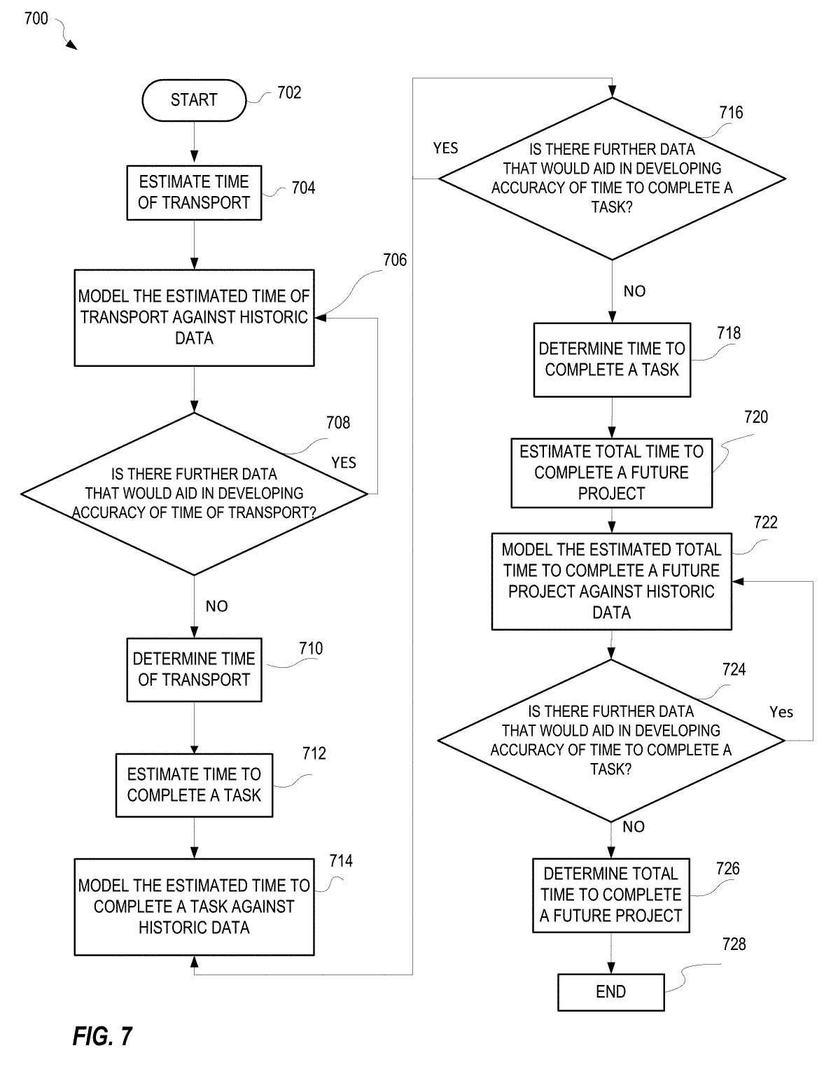

Finally, in step 212, the program predicts a total time to complete the project via method 700 as discussed below (FIG. 7). The method ends at step 214.

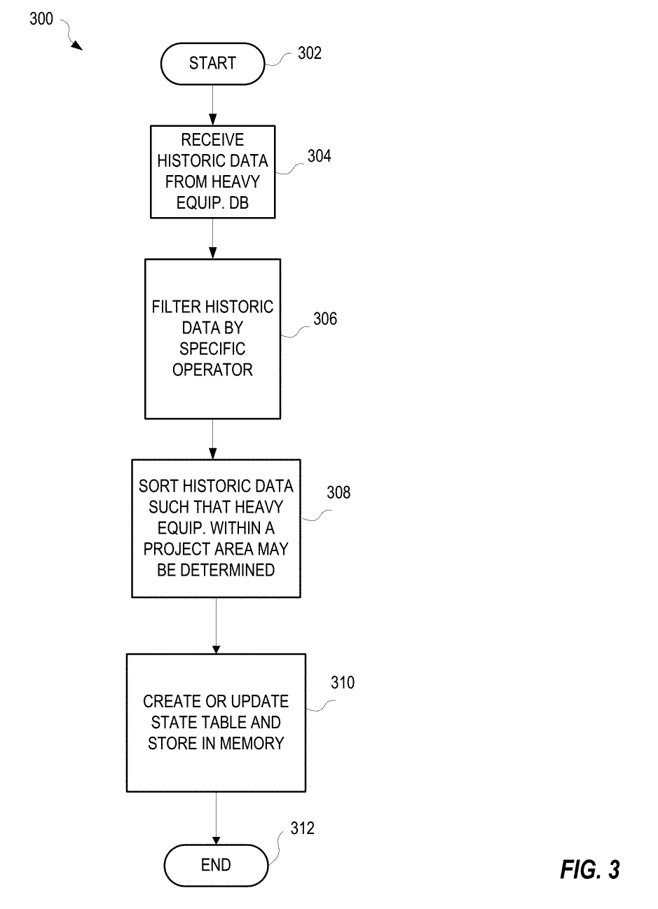

Thus, the method 200 involves receiving known data (if available) or estimating, based on historical information, data for several variables known to have an effect on the timing it takes an operator to develop a predetermined tract of land. If the variable is known (i.e. rig count), then the sub-method concerning calculating that variable may be skipped. It is understood that each variable may include a prompt for a user 136 to input the variable, if known, known into the tool 118. The sub-methods of estimation are now described below, with reference to FIGS. 3-8.

Beginning with FIG. 3, a sub-method 300 for retrieving data is shown. This sub-method is runs in a loop at predetermined time intervals to retrieve additional data (stored as historical data) from the heavy equipment database 150. The historical data retrieved from the database 150 will be used in each method to better model behavior patterns of operators and predict total time for an operator to complete a project. The first time the sub-method 300 runs, the amount of data processed by the tool 118 may be significantly larger, as opposed to iterative runs, wherein only the last project or last data set will be retrieved from the database 150 and stored in memory 114.

In step 302, the sub-method 300 begins. In embodiments, the data acquisition module 120 is activated by the user 136. In step 304, the historical data from the heavy equipment database 150 (which, as noted, may be multiple databases) for every job or project previously tracked for each operator is downloaded from the heavy equipment database 150. Heavy equipment data may currently be retrieved from already existing databases such as Drilling Info (DI) or IHS Market.

In step 306, the data is filtered by the operator or the company that owns and utilizes the heavy equipment, to be used for the project and stored in memory 114. Once the heavy equipment data is grouped by operator, in step 308, the heavy equipment (or rigs) owned by those operators can be sorted based on specific rig data, which may include a time stamp (e.g. GPS latitude and longitude on 10/1/16). Once the data is sorted by rig or heavy equipment, then in step 310, a state table may be created (or updated, as the case may be) concerning each rig. A state table may show each change in state for each particular rig over a given period (e.g., for the time that records for the operator exists, or a subset thereof). Such state changes may include variables that may be tracked as data and that a drilling rig site operator may wish to review including but not limited to rig count in an area, well API numbers, rig location, well lateral length, permit date changes, rig spud dates, rig release dates, formation of well, and formation depth. The state table is saved to memory 114. As sub-method 300 is repeated, and for each repetition, only new data, if available, will be retrieved and the state table will be updated with the newest information. Due to the size of the data to be transferred, optionally, this sub-method 300 may only retrieve data for a single operator at step 304. Accordingly, the sub-method 300 would be repeated for every desired operator.

The sub-method 300 may be repeated daily or at a set time interval (e.g., hourly, weekly, and the like) in which data is updated in the heavy equipment database 150 to monitor the state changes for all operators and to update prediction models, as will be discussed further below.

Moving on, FIG. 4 illustrates a sub-method 400 for determining the rig count. The number of rigs used by an operator for previous projects may be known from the historical data retrieved in sub-method 300. To predict how many rigs will be used for a potential project, the following w variables or factors may be considered: historic heavy equipment location data, a commodity basin location, well surface locations, production data (decline curves for production may be developed (e.g., using decline curve analysis) as is known to those of skill in the art and utilized), an expected ultimate recovery at the commodity basin location, geography or geological properties at the project location, distance from other heavy equipment positions or locations, anticipated well lateral length, and rig(s) capabilities (e.g., horse power, speed of movement, and the like). Some of these w variables may change as the project continues, and some may not be known at the initial outset of a project (e.g., well lateral length or distance of well from current rig position if there are no wells dug yet). Accordingly, the sub-method 400 may be completed with unknown w variables, which may be ignored (e.g., given a value of zero). The known w variables may be collected from the historical data or past data from the heavy equipment database as discussed in sub-method 300. As more data is accumulated and more w variables become known, the accuracy of the sub-method 400 is increased. Therefore, sub-method 400 may be repeated at the conclusion of each operator project, or alternately, at set time intervals, to learn and iteratively adapt based on new information.

The sub-method 400 is activated by the rig count module 122 in step 402. In step 404, an initial estimate for rig count is made. This estimate could be as simple as one rig or an average of the rig count over the total amount of projects for a given operator (computed from state table of historical data stored in memory 114) for example. Alternately, the estimate may be based on a number of rigs used for a similarly sized tract of land by the operator for a previous project.

At step 406, the sub-method 400 self-learns (or updates the estimates) by taking the initial estimate from step 404 and modeling it against the actual numbers in the historical data. Step 406 may include modeling in the form of linear regression, logarithmic regression, and/or non-linear regression using known methods (e.g., least square approach, least absolute deviation approach, random forest regression, boosted tree model, etc.). Regression may be used to fit a predictive model to observed rig count historical heavy equipment data and variables (e.g., the w variables as discussed above). W variables may be related to rig count, depending on the operator. Non-linear and/or linear regression can be applied to quantify the strength of the relationship between rig count and the w variables. One or more linear and/or non-linear regression methods may be used in step 406 to determine which modeling approach fits the data the best. The modeling can include subsets and not just one historical data set to estimate another data set. For example, four data sets may be used as a subset and may be modeled in order to estimate a fifth data set to compare the different modelling approaches.

After developing a fitted model, the model can be used to make a prediction of the value of rig number or count. In step 408, if further historical data exists in memory 114 or database 150 that would aid in developing the accuracy of rig number, then step 406 is repeated with the most recent historical heavy equipment data set for the current project (or another project) for the same operator.

It should be understood that the sub-method 400 may be repeated in its entirety for each operator. Step 408 is repeated until the historical data no longer includes relevant updated data. For example, a project may be finalized when all wells are dug and the commodity has been completely depleted or for all intents and purposes depleted and all the rigs at the location are moved off site to the next project (e.g. rig count is zero). No additional data may be received, because no further action is occurring. It may also be that the rig has reached a predetermined destination, after which location data is no longer updated.

The sub-method then moves to step 410, where a new rig number is determined. The sub-method ends at step 412. Therefore, the sub-method 400 is constantly learning with each iteration of the method 200, and the sub-method will re-determine the rig number with the latest data from the sub-method 300.

With reference now to FIG. 5, a sub-method 500 to predictor determine well density is shown. The sub-method 500 is initiated by the well density module 124 in step 502. Well density of a particular location depends on the drilling spacing unit, which is an area allotted to a well. The well density of a tract of land often depends on the geologic structure, the size of the reservoir, the commodity in the reservoir, etc. Accordingly, well density is not necessarily (or even likely) to be the same across projects. In step 504, an initial estimate of well density is made for the given tract of land. This initial estimate could be as simple as one well per second of land (640 acres) or an average of the well density over the total amount of projects for a given operator (computed from the state table of historical data stored in memory 114) as described above.

At step 506, the sub-method 500 updates the estimate by taking the initial estimate and modeling it against the actual numbers in the historical data for a given finalized project. Step 506 may include modeling in the form of linear regression, logarithmic regression, and/or non-linear regression using known methods (e.g., least square approach, least absolute deviation approach, random forest regression, boosted tree, etc.). Regression may be used to fit a predictive model to observed well density historical heavy equipment data and the w variables discussed above. W variables may be related to well density or not depending on the operator. Linear and non-linear regression can be applied to quantify the strength of the relationship between well density and the w variables. Some of these w variables may change as the project goes on and some will not be known at the initial outset of a project (e.g., well lateral length or distance of well from current rig position if there are no wells dug yet). Accordingly, the sub-method 500 may be completed with unknown w variables, which may be ignored (e.g., given a value of zero). The known w variables may be collected from the historical data from the heavy equipment database 150 as discussed in sub-method 300.

One or more linear and/or non-linear regression methods may be used in step 506 to determine which modeling approach fits the data the best. The modeling can include subsets and not just one historical data set to estimate another data set. For example, four data sets may be used as a subset which may be modeled to estimate a fifth data set to compare the different modelling approaches.

After developing a fitted model, the model can be used to make a prediction of the value of well density. In step 508, if further historical data exists in memory 114 or database 150 that would aid in further developing the accuracy of well density, then step 506 is repeated with the most recent historical heavy equipment data set for that single operator. As more data is accumulated, the accuracy of the method 500 is increased. Step 508 is repeated until the historical data no longer includes relevant updated data or data that would assist in predicting a well density of an operator.

The model determines a quantity for well density at step 510, and the method ends at step 512. Sub-method 500 may be repeated at the conclusion of each operator project, or at set time intervals, to learn and iteratively adapt based on the data retrieved from sub-method 300.

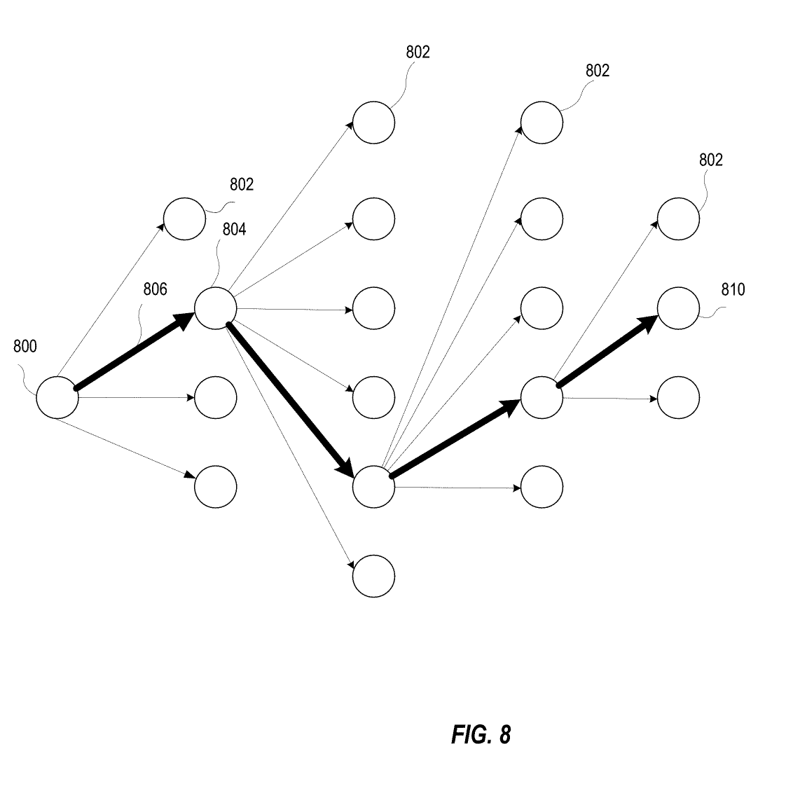

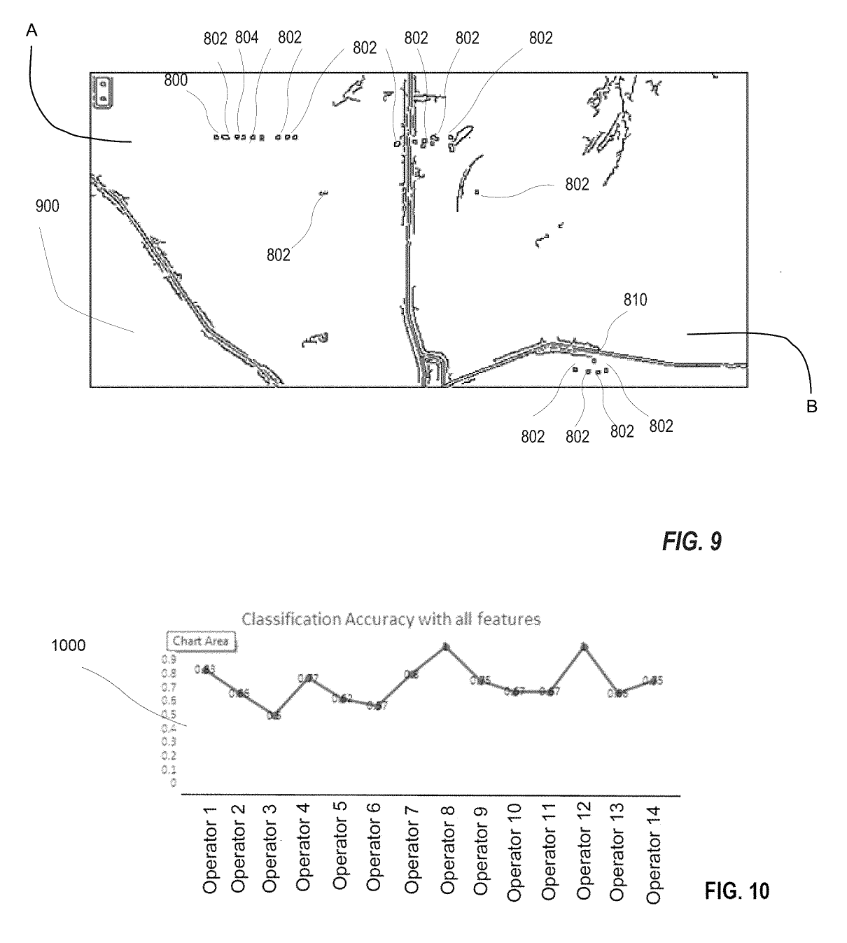

Moving on, FIG. 6 illustrates a sub-method 600 of predicting or determining heavy equipment movement. The method 600 is initiated by the heavy equipment movement module 126 in step 602. Referring to FIGS. 8-9, at any given time during the project, the heavy equipment may move between a number of possible candidate locations 802. In step 604, an initial candidate location 804 is selected to which the rig may move from a starting location 800. This selection 804 could be as simple as choosing the closest candidate location that has a valid permit (computed from state table of historical data stored in memory 114). A pathway 806 is selected (shown in bold) with each iteration of the method 600.

FIG. 9 shows a single iteration of step 604, where a selection 804 is made, and all the possible candidate locations 802 are displayed by dots visibly shown on a terrain 900. The user may wish to know how long it would take a particular operator to move from one end A of the terrain to the other end B of the terrain and how many wells will be dug in-between end A to end B (FIG. 8). These locations 802 are limited by where the operator has a right to drill at that point in time (e.g., permit is still valid). FIGS. 8-9 may be displayed to the user 136 while method 600 is running by means of the output 112 or the GUI 160.

The sub-method 600 updates by taking the selection 804 and modeling the selection against the actual candidate location 804 selection in the historical data at step 606 for a given project. Step 606 may include modeling in the form of linear regression, logarithmic regression, and/or non-linear regression using known methods, (e.g., least square approach, least absolute deviation approach, random forest, boosted tree, etc.). Regression may be used to fit a predictive model to observed heavy equipment movement historical heavy equipment data and x variables. X variables that may be considered by the sub-method may include, but are not limited to: distance to candidate position from current position, number of candidate locations, cumulative production features, distance of other heavy equipment from candidate locations, proximity of target location to infrastructure elements (e.g., pipeline), estimated ultimate recovery of candidate positions, oil price at the time of selection, geological properties of the candidate positions, target formation at the candidate position, and permit expiration date for candidate positions. X variables may be related to rig movement, depending on the operator. Linear and non-linear regression can be applied to quantify the strength of the relationship between rig movement and the x variables.

One or more linear and/or non-linear regression methods may be used in step 606 to determine which modeling approach fits the data the best. The modeling can include subsets and not just one historical data set to estimate another data set. For example, four data sets may be used as a subset which may be modeled to estimate a fifth data set to compare the different modelling approaches.

Some of the x variables may change as the project continues and the sub-method 600 will self-learn from this. If the sub-method 600 is run with unknown x variables, these x variables are ignored (e.g., given a value of zero). The known x variables may be collected from the latest upload of iterative data from the heavy equipment database 150 as discussed regarding sub-method 300.

After developing a fitted model, the model can be used to make a prediction of the value of rig movement. In step 608, if further historical data exists that would aid in further developing the accuracy of rig movement, then step 606 is repeated with the most recent historical heavy equipment data set.

It should be understood that this sub-method 600 may be repeated in its entirety for one or more operators. Step 606 is repeated until the historical data no longer includes a relevant updated data or data that would assist in predicting rig movement of an operator. A prediction of rig movement for the entire project or from a starting location to a second location is determined at step 610. The method ends at step 612. Sub-method 600 may be repeated at the conclusion of each operator project, or at set time intervals, to learn and iteratively adapt based on the retrieved data from sub-method 300.

Referring now to FIG. 7, a sub-method for determining time of rig movement or time of transport of the rig and drilling time is shown. The sub-method 700 begins at step 702, which is at the conclusion of the rig movement module 126. In step 704, an initial estimate for time of transporting the rig (Tₜᵣₐₙₛₚₒᵣₜ) is made. This estimate could be simply based on the distance to be moved in a straight line and the average rate of movement for the specific heavy equipment of the operator (which may be computed from state table of historical data stored in memory 114 or may be known for the precise piece of equipment). The sub-method is updated by modeling the estimate against the actual time in the historical data at step 706 for a given project or for a given location (e.g. destination). The step 706 may include modeling in the form of linear regression, logarithmic regression, and/or non-linear regression using known methods (e.g., least square approach, least absolute deviation approach, boost tree, decision tree, random forest, etc.). Regression may be used to fit a predictive model to an observed time of movement historical heavy equipment data and y variables. The y variables may be a subset of w variables and may include the rig capabilities, such as the maximum land speed of the heavy equipment. As there are various models of rigs, and as the heavy equipment to be used for the potential project is not known, only an estimation based on historical data may be made. It should be noted that linear and/or non-linear regression can be applied to quantify the strength of the relationship between Tₜᵣₐₙₛₚₒᵣₜ and the y variables.

One or more linear and/or non-linear regression methods may be used in step 706 to determine which modeling approach fits the data the best. It is foreseen that the modeling can include subsets and not just one historical data set to estimate another data set. For example, four data sets may be used as a subset which may be modeled to estimate a fifth data set to compare the different modelling approaches.

In step 708, if further historical data exists in memory 114 that would aid in further developing the accuracy of Tₜᵣₐₙₛₚₒᵣₜ, then step 706 is repeated with the next historical heavy equipment data set of the next candidate location for that single operator. Step 706 is repeated until the historical data no longer includes data helpful in determining Tₜᵣₐₙₛₚₒᵣₜ. The time to transport a rig from location or position 800 to position 810 (FIG. 8) is determined in step 710. The position or location 810 may be the final well to be dug or it may be a well in a location 810 that the user 136 wants to know how long a particular operator will take to get there.

In step 712, an initial estimate for time of completing a task (e.g. dig a well) (Tₜₐₛₖ) is made. This estimate could be as simple as the averages based on z variables, which may be a subset of w variables, such as: well depth, well lateral length, well location, geological properties at the well location, and rig capabilities for the heavy equipment of the operator (e.g., drill horse power, drill speed, and the like). The heavy equipment to be used is not known, so this portion of the sub-method 700 will be an estimation based on historical data of rigs previously used by the operator. Furthermore, when given specific geological properties of a candidate location, it is unknown how wide the well lateral length will be or how deep the well will be dug, so an estimation based on the historical data of how the rigs have performed under similar conditions (if available) will be used in step 712 to determine Tₜₐₛₖ.

Step 714 updates by modeling the Tₜₐₛₖ estimate against the actual time to complete drilling of wells in the historical data for a given finalized project. The step 714 may include modeling in the form of linear regression, logarithmic regression, and/or non-linear regression using known methods (e.g., least square approach, least absolute deviation approach, etc.). Regression may be used to fit a predictive model to observed time to complete single well historical heavy equipment data, and z variables. The z variables are presumed to impact Tₜₐₛₖ, and linear regression may be applied to quantify the strength of the relationship between Tₜₐₛₖ and the z variables.

One or more linear and/or non-linear regression methods may be used in step 714 to determine which modeling approach fits the data the best. The modeling can include subsets and not just one historical data set to estimate another data set. For example, four data sets may be used as a subset which may be modeled to estimate a fifth data set to compare the different modelling approaches.

In step 716, if more historical data exists in memory 114 that would aid in further developing the accuracy of Tₜₐₛₖ, then step 714 is repeated with the next historical heavy equipment data set of the next candidate location for that single operator.

In step 718, the time to complete individual wells (Tₜₐₛₖ) is determined. In step 720, the total time (Tₜₒₜₐₗ) for a potential well project can be estimated by the summing of all Tₜₐₛₖ for each well and the Tₜᵣₐₙₛₚₒᵣₜ for each candidate location and each rig. Tₜₒₜₐₗ may also be a known quantity in the historical data, and can be comparably checked for accuracy (e.g., within the same order of magnitude). Therefore, in step 720, the calculated Tₜₒₜₐₗ is taken as an initial estimate.

The sub-method 700 continues at step 722 to update by taking the Tₜₒₜₐₗ estimate and then modeling the Tₜₒₜₐₗ estimate against the actual time to complete a finalized project in the historical data. Step 722 may include modeling in the form of linear regression, logarithmic regression, and/or non-linear regression using known methods (e.g., least square approach, least absolute deviation approach, etc.). The variables that are presumed to impact Tₜₒₜₐₗ may include: Tₜₐₛₖ and Tₜᵣₐₙₛₚₒᵣₜ for a single operator. The closer the determinations of Tₜₐₛₖ in step 718 and Tₜᵣₐₙₛₚₒᵣₜ in step 710 to the true answers in the historical data, the closer that Tₜₒₜₐₗ will also be. The final recursive step 724 may adjust for those small errors in seen the variables, if appropriate.

In step 724, if more historical data exists in memory 114 that would aid in further developing the accuracy of Tₜₒₜₐₗ, then step 722 is repeated. It should be understood that this step 722 may require the additional steps of the sub-method 700 to be repeated in their entirety. Step 724 may be just a quick double check to see if the data in method 300 has just been updated. Step 724 is repeated until the historical data no longer includes data helpful in determining Tₜₒₜₐₗ.

In step 726, the total time to complete a potential project with a given terrain and a specific operator is estimated, and the process ends at step 708. This solution may output to the user 136 via the output device 112 or GUI 160. The user 136 may utilize this knowledge, to better select an operator for a given piece of land or terrain with known geological properties. The total time determination taking into account the known geological properties of the terrain. It should be understood that this method 700 may be repeated in its entirety for one or more operators.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. Further, it will be understood that certain features and subcombinations may be of utility and may be employed within the scope of the disclosure. Further, various steps set forth herein may be carried out in orders that differ from those set forth herein without departing from the scope of the present methods. This description shall not be restricted to the above embodiments.

### EVALUATION RESULTS EXAMPLE

FIG. 10 illustrates a graph 1000 showing the accuracy of sub-method 600 (e.g., step 610) with regards to predicting rig movement with respect to several operators. In this graph 1000, the sub-method 600 predicted the movement of operator A with 83% accuracy, operator B with 66% accuracy, operator C with 50% accuracy, and so forth. For 14 operators tested, an average of 73% accuracy was achieved in predicting rig movement.

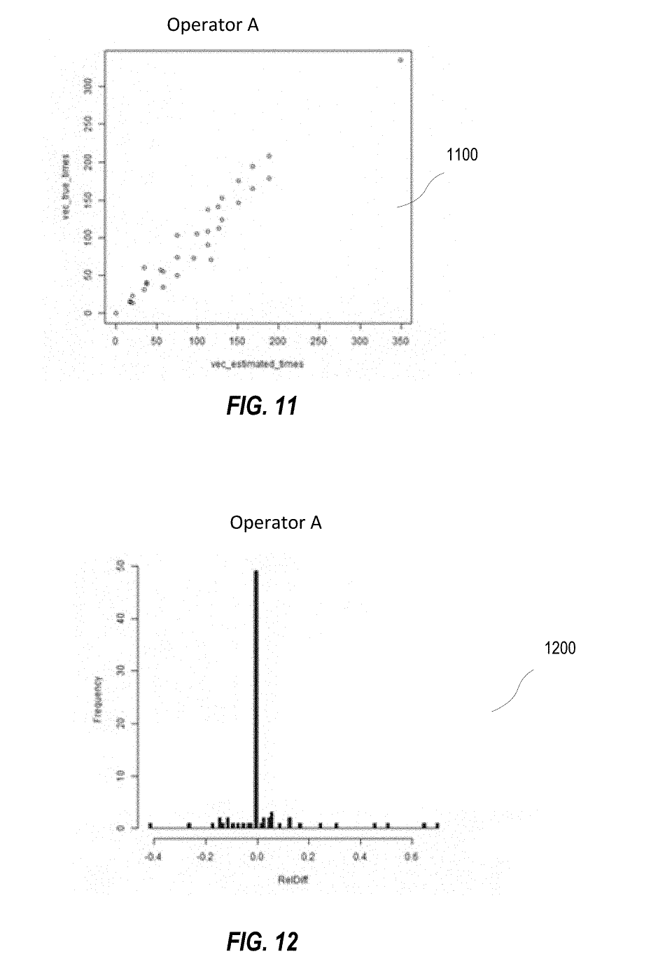

FIG. 11 shows a scatter plot 1100 of Ttransport of sub-method 700 for an operator A. The scatter plot 1100 displays values of the true (y-axis) and the predicted (x-axis) Ttransport determination of step 710 for operator A. The relationship of the two variables shows an almost perfect linear relationship, indicating the prediction is rather accurate.

With reference to FIG. 12, a histogram 1200 shows a distribution of Ttransport of method 700 for an operator A. The histogram 1200 plots the frequency of the relative difference between the true and the predicted Ttransport determination of step 710 for operator A. A zero relative difference had the highest frequency at nearly 50%.

Those of skill in the art shall understand that the graphical results may be relayed to a user 136, e.g., via the output device 112 or the GUI 160.

1. A self-learning method to assist in determining a total time to complete a potential project, the method involving a plurality of historical heavy equipment information, the method being implemented on one or more computing systems, and comprising the steps of:
receiving a request for an estimated total time to complete a potential project from a user, the potential project including a quantity of a terrain, an operator, and at least one geological property of the terrain;
accessing a first portion of the historical heavy equipment information for heavy equipment for the operator, the first portion of the historical heavy equipment information including information concerning the movement of heavy equipment used by the operator for a first historical project;
calculating a prediction for movement of heavy equipment used in the potential project by the operator based on the first portion of historical heavy equipment information;
accessing a second portion of the historical heavy equipment information for the operator, the second portion of the historical heavy equipment information including information concerning the movement of heavy equipment for a second historical project;
providing an updated prediction for movement of heavy equipment used in the potential project based on the second portion of the historical heavy equipment information;
predicting a total estimated time for the potential project utilizing the updated prediction for movement of heavy equipment used in the potential project; and
sending, in response to the request, the estimated total time to complete the potential project.

2. The method of claim 1, wherein the first and second portions of the historical heavy equipment information further includes data with respect to the operator for at least one of: heavy equipment location, a commodity basin location, a well surface location, an expected ultimate recovery at the commodity basin location, geological properties at the potential project location, distance from other heavy equipment positions, and a well lateral length.

3. The method of claim 2, wherein, in the step of calculating, the calculation gives a value of zero for information not provided.

4. The method of claim 2, wherein in the step of updating includes at least one of a linear or non-linear regression of the data with respect to the updated prediction for movement of heavy equipment to be used in the potential project by the operator.

5. The method of claim 4, wherein the data is used as a variable to quantify the strength of a relationship between the variable and the movement of heavy equipment.

6. The method of claim 1, wherein in the steps of accessing and calculating are repeated for the plurality of historical heavy equipment information for the operator.

7. The method of claim 1, wherein the receiving step occurs within a predetermined time interval during which the plurality of historical heavy equipment information is updated.

8. The method of claim 7, wherein, after a predetermined time interval has lapsed and the heavy equipment information is updated, the step of accessing of the second portion and the step of providing an updated prediction for movement occurs prior to a re-initiation of the method.

9. The method of claim 1, wherein prior to the step of accessing, the plurality of heavy equipment information is sorted by operator, location, and time interval, and wherein each time interval further defines the first and second portions of the historical heavy equipment information.

10. The method of claim 1, wherein, during the calculating step, an initial estimated heavy equipment number is made.

11. The method of claim 10, wherein the initial estimate is based on an average of heavy equipment movements taken from the plurality of historical heavy equipment information for the operator.

12. The method of claim 1, wherein the first portion of historically heavy equipment information further includes at least one of: well density, quantity of wells dug, time to dig a well, and total time to complete the first historical project.

13. A self-learning system, comprising:
a processor;
an application programing interface communicating with a heavy equipment database containing a plurality of historical heavy equipment data that is updated at a predetermined time interval;
a storage medium for a storing portion of the historical heavy equipment data relating to a specific operator and movement of heavy equipment owned by that operator;
a calculating device for calculating, upon request by a user, a total time to complete a potential project based on the portion of historical heavy equipment information; and
an output device for displaying the calculated total time for the potential project;
wherein the request by the user includes information about the potential project including a quantity of a terrain, an operator, and geological property of the terrain; and
wherein the calculating device updates the calculated total time for the potential project calculation with the data that is updated at the predetermined time interval.

14. The self-learning system of claim 13, wherein the portions of the historical heavy equipment information further relates to at least one of: well density, quantity of heavy equipment, quantity of wells dug, time to dig a well, and total time to complete a historical project.

15. A non-transitory computer readable medium with computer executable instructions stored thereon executed by a digital processor to perform a self-learning method comprising:
instructions for receiving a request for an estimated total time to complete a potential project from a user, the request including information about the potential project including a quantity of a terrain, an operator, and a geological property of the terrain;
instructions for accessing a first portion of the historical heavy equipment information for heavy equipment for the operator, the first portion of the historical heavy equipment information including information concerning the movement of heavy equipment used by the operator for a first historical project;
instructions for calculating a prediction for movement of first heavy equipment used in the potential project by the operator based on the first portion of historical heavy equipment information;
instructions for accessing a second portion of the historical heavy equipment information for the operator, the second portion of the historical heavy equipment information including information concerning the movement of heavy equipment for a second historical project;
instructions for calculating a second prediction for movement of heavy equipment used in the potential project by an operator based on the second portion of the historical heavy equipment information;
instructions for calculating a total estimated time to complete the potential project utilizing the updated second prediction; and
instructions for sending, in response to the request, the estimated total time to complete the potential project.

16. The method of claim 15, wherein the first and second portions of the historical heavy equipment information further include information concerning at least one of: well density, quantity of wells dug, quantity of heavy equipment, time to dig a well, and total time to complete a historical project.

17. The method of claim 16, further comprising instructions for calculating a first well density to be used in the potential project by the operator based on the first portion of historical heavy equipment information, and instructions for calculating a second well density to be used in the potential project by an operator based on the second portion of the historical heavy equipment information, wherein the steps of calculating the first well density and the second well density are completed prior to calculating the total estimated time to complete the potential project.

18. The method of claim 16, further comprising instructions for determining a first number of rigs to be used in the potential project by the operator based on the first portion of historical heavy equipment information and instructions for determining a second number of rigs to be used in a project by an operator based on the second portion of the historical heavy equipment information, wherein the steps of calculating the first number of rigs and the second number of rigs are completed prior to calculating the total estimated time to complete the potential project.

19. The method of claim 16, wherein the request for an estimated total time to complete a potential project from a user further includes a specified quantity of rigs to be used in the potential project.

20. The method of claim 16, further comprising instructions for calculating a first time to complete a well to be used in the potential project by the operator based on the first portion of historical heavy equipment information and instructions for calculating a second time to complete a well to be used in a project by an operator based on the second portion of the historical heavy equipment information, wherein the steps of calculating the first time to complete a well and the second time to complete a well are completed prior to calculating the total estimated time to complete the potential project.
